(19) United States
(12) Patent Application Publication
(10) Pub. No.: US 2026/0034806 A1
(43) Pub. Date: Feb. 5, 2026

(54) SYSTEM AND METHOD FOR ELECTROSTATICALLY ASSISTING INK DRYING IN AN AQUEOUS INKJET PRINTER

(71) Applicant: Xerox Corporation, Norwalk, CT (US)

(72) Inventors: Palghat S. Ramesh, Pittsford, NY (US); Erwin Ruiz, Rochester, NY (US); Megan Zielenski, Holland Patent, NY (US); Nicolas C. Pietrantoni, Webster, NY (US); Samuel E. Kuhl, Williamson, NY (US)

(21) Appl. No.: 18/789,992

(22) Filed: Jul. 31, 2024

(51) Int. Cl. B41J 11/00

(52) U.S. Cl. CPC B41J 11/0022; B41J 11/00216

(57) ABSTRACT

An inkjet printer includes one or more devices to increase evaporation rates within one or more dryers in the inkjet printer. An electrostatic charge generator can be positioned before a dryer to charge media and liquid materials ejected onto the media before the media enters the dryer to increase evaporation rates. An electric field generator within the dryer can be operated to generate an electric field that is directed toward the media to increase the movement of the vapor cloud away from the media being carried by a media transport within the dryer. Additionally, a corona generator can be coupled to an AC high frequency current to generate a corona wind to increase evaporation rates within the dryer.

### TECHNICAL FIELD

This disclosure relates generally to inkjet printers that produce ink images on media, and more particularly, to ink dryers used in such printers.

### BACKGROUND

Inkjet imaging devices, also known as inkjet printers, eject liquid ink from printheads to form images on an image receiving surface. The printheads include a plurality of inkjets that are arranged in an array. Each inkjet has a thermal or piezoelectric actuator that is coupled to a printhead controller. The printhead controller generates firing signals that correspond to digital data content for the images to be printed. The actuators in the printheads respond to the firing signals by expanding into an ink chamber to eject ink drops onto an image receiving surface and form an ink image that corresponds to the digital image content used to generate the firing signals. The image receiving surface is usually a continuous web of media material or a series of media sheets.

Inkjet printers used for producing color images typically include multiple printhead assemblies. Each printhead assembly includes one or more printheads that usually eject a single color of ink. In a typical inkjet color printer, four printhead assemblies are positioned in a process direction with each printhead assembly ejecting a different color of ink. The four ink colors most frequently used are cyan, magenta, yellow, and black. The common nomenclature for such printers is CMYK color printers. Some CMYK printers have two printhead assemblies that print each color of ink. The printhead assemblies that print the same color of ink are offset from each other by one-half of the distance between adjacent inkjets in the cross-process direction to double the number of pixels per inch density of a line of the color of ink ejected by the printheads in the two assemblies. As used in this document, the term “process direction” means the direction of movement of the image receiving surface as it passes the printheads in the printer and the term “cross-process direction” means a direction that is perpendicular to the process direction in the plane of the image receiving surface.

In these printers, one or more dryers are positioned after the printhead assemblies to dry the ink ejected onto the media sufficiently so the ink does not rub off onto rollers and other parts along the transport path that may contact the printed media. Currently, large scale aqueous ink printers print media at a maximum speed that is based on the weight of the media, usually expressed in grams per square meter (gsm) and the amount of ink required for an image. While printing heavier media with larger amounts of ink is desirable, these higher limits cannot be reached because the dryers cannot sufficiently dry the ejected ink. The obvious solution to increase dryer capacity is to decrease speed through a dryer, which impacts productivity, or increase the thermal output of the dryer, or add dryers along the media transport path. The last two options significantly increase the cost and the footprint of the printer.

The evaporation rate of a liquid is determined by the vapor pressure at the liquid surface and the rate of diffusion of vapor through the air above the liquid. The vapor pressure is a function of the temperature of the liquid, while the diffusion rate is typically limited by the boundary layer that forms above the surface of the liquid. Higher vapor pressures result in higher evaporation rates. In aqueous inks, the volatile components within the ink are water and co-solvents, such as glycols and glycerols. The co-solvents usually have lower vapor pressures because they have boiling points that are greater than water. In printer ink dryers, a dynamic equilibrium between evaporation and condensation occurs in a thin layer above the surface of the liquid, sometimes known as the Knudsen layer. A thicker boundary layer forms above the Knudsen layer based on the external flow field. The net evaporation rate at the ink surface is related to the diffusion of vapor in the boundary layer. External air flow, for example, using an air knife to direct air toward the media in a direction perpendicular to the media, or by mechanically mixing or disturbing the air in the boundary or Knudsen layer increases the rate of vapor diffusion in these layers. This perturbation of the boundary layer has a limit as increasing airflow near the liquid surface could disturb the placement of the ejected ink image and adversely impact ink image quality. Improving diffusion rates in the air above the surface of the ink without disturbing the ink image would be beneficial.

### SUMMARY

A new color inkjet printer is configured with a dryer having an electrostatic field generator that electrostatically assists the ink drying within the dryer by increasing airflow near the liquid surface of the ink. The inkjet printer includes a media transport configured to move media through the inkjet printer in a process direction; and an electrostatic charge generator positioned to direct electrostatic charge toward the media being moved by the media transport to improve an evaporation rate in material applied to the media being moved by the media transport.

A new method of operating a dryer in an inkjet printer electrostatically assists the ink drying within the dryer by increasing airflow near the liquid surface of the ink. The method includes operating a media transport to move media through the inkjet printer in a process direction; and operating an electrostatic charge generator to direct electrostatic charge toward the media being moved by the media transport to improve an evaporation rate in material applied to the media being moved by the media transport.

### BRIEF DESCRIPTION OF THE DRAWINGS

The foregoing aspects and other features of increasing evaporation rates within a dryer in an color inkjet printer are explained in the following description, taken in connection with the accompanying drawings.

FIG. 1 is a schematic drawing of a color inkjet printer that is configured with an electrostatic charge generator to charge the ink images on printed media before the media enters an ink dryer.

FIG. 2 is a schematic of the electrostatic charge generator used in the printer of FIG. 1.

FIG. 3 is a schematic of an alternative embodiment of the printer of FIG. 1 that incorporates an electrostatic field generator to generate a corona wind to increase an evaporation rate of ink from media.

FIG. 4 is a schematic showing a preheater that is used with the electrostatic field generator of FIG. 3.

FIG. 5 is a flow diagram of a process used to operate the printer of FIG. 1.

### DETAILED DESCRIPTION

For a general understanding of the environment for the printer and drying system disclosed herein as well as the details for the printer and drying system, reference is made to the drawings. In the drawings, like reference numerals have been used throughout to designate like elements. As used herein, the word “printer” encompasses any apparatus that ejects ink drops onto media to form ink images. The printer and drying systems described below use an electrostatic charge generator and an electrostatic field generator to improve airflow above the surface of the ink that has been ejected onto the media.

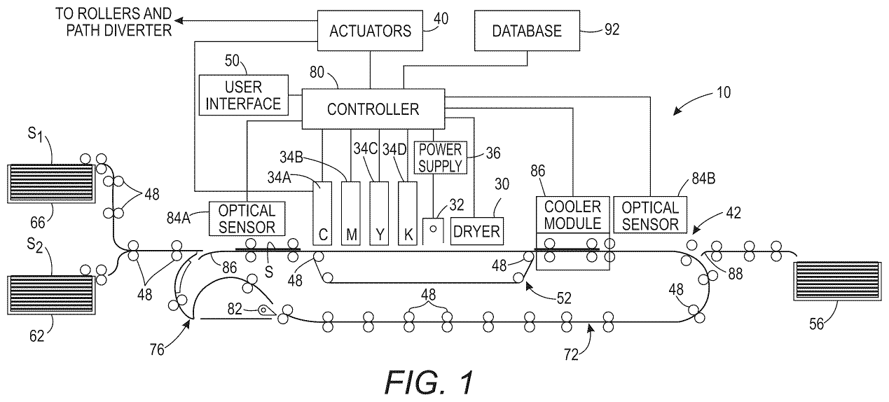

FIG. 1 depicts a high-speed color inkjet printer 10 that is configured to improve evaporation rates within ink dryers of the inkjet printer without increasing the production costs or expanding the footprint of the printer over previously known printers. As illustrated, the printer 10 is a printer that directly forms an ink image on a surface of a media sheet stripped from one of the supplies of media sheets S₁ or S₂ and the sheets S are moved through the printer 10 by the controller 80 operating one or more of the actuators 40 that are operatively connected to pulleys or to at least one driving pulley of conveyor 52 that comprises a portion of the media transport 42 that passes through the print zone PZ of the printer. As used in this document, the term “print zone” means the portion of the media transport that is opposite any of the printhead assemblies in the printer.

The printer 10 is configured to perform print jobs sent to the printer by an external data source. As used in this document, the term “print job” means ink image content data for a series of ink images to be produced by a printer and the print job parameters at which the printer is operated to produce the ink images. The ink image content data is sent to the controller 80 from either an external data source, such as a scanning system or an online or work station connection. The ink image content data is processed to generate the inkjet ejector firing signals delivered to the printheads in the modules 34A-34D. Along with the ink image content data, the controller also receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, media manufacturer, and the like for executing a print job. As used in this document, the term “print job parameters” means non-image content data for performing a print job and the term “ink image content data” means digital data that identifies a color and a volume of each ejected ink drop that forms pixels in the ink images to be printed on the media sheets produced by a print job.

In one embodiment, each printhead module of the printer 10 has only one printhead that has a width that corresponds to a width of the widest media in the cross-process direction that can be printed by the printer. In other embodiments, the printhead modules have a plurality of printheads with each printhead having a width that is less than a width of the widest media in the cross-process direction that the printer can print. In these modules, the printheads are arranged in an array of staggered printheads or a linear array of abutting printheads to enable media wider than a single printhead to be printed. Additionally, the printheads within a module or between modules can also be interlaced so the density of the drops ejected by the printheads in the cross-process direction can be greater than the smallest spacing between the inkjets in a printhead in the cross-process direction. Although printer 10 is depicted with only two supplies of media sheets, the printer can be configured with three or more sheet supplies, each containing a different type or size of media.

The media transport 42 includes a belt for moving print media, such as paper sheets, envelopes, or any other article suitable for receiving printed images, through the print zone so the printheads can eject ink drops onto the moving media to form printed images on the media. The belt includes a grounding plane that can be selectively coupled to electrical ground. Each print medium lies on the surface of the belt as the belt moves through the printer. Electrostatic charge generated by electrostatic charge generator 32 is directed toward the grounding plane on the far side of the belt from the generator 32 and charges the media and the ink image. It also helps hold each print medium in place as they pass through the dryer 30 where increased airflows help increase diffusion rates in the boundary layer above the media. In large-scale printer configurations, the belt often carries multiple print media simultaneously in a serial manner.

After printed media passes the electrostatic charge generator 32, the ink and the exposed media are charged to the grid voltage of the electrostatic charge generator. The electrostatic charge generator, for example, can be a high voltage DC scorotron, a high voltage AC discorotron, or the like. As used in this document, the term “electrostatic charge generator” means a device that delivers an electrostatic charge to media and an ink image on the media prior to the media entering a dryer. The controller is configured with programmed instructions stored on non-transitory, computer readable media that when executed by the controller cause the controller to operate the power supply 36 to couple the generator 32 to electrical power so the generator charges the ink and media to a specified charge density equal to the grid voltage of the generator 32. The grid voltage (Vgrid) is adjusted for different media weights to maintain the same charge density on the ink (σᵢₙₖ) across different media weights as follows:

$${σ}_{i n k} = ε0 \frac{V grid}{{t}_{p} / {K}_{p}}$$

where tₚ is the media thickness, Kₚ is the dielectric constant of the media, and ε₀ is the permittivity of free space. The belt on which the media rides through the electrostatic charge generator is electrically conductive. The conductivity of the belt is γ_{b}>>K_{b} ε₀U/L_{c}, where K_{b} is the dielectric constant of the belt, U is the speed of the belt, L is the footprint of the generator, and the belt is electrically grounded.

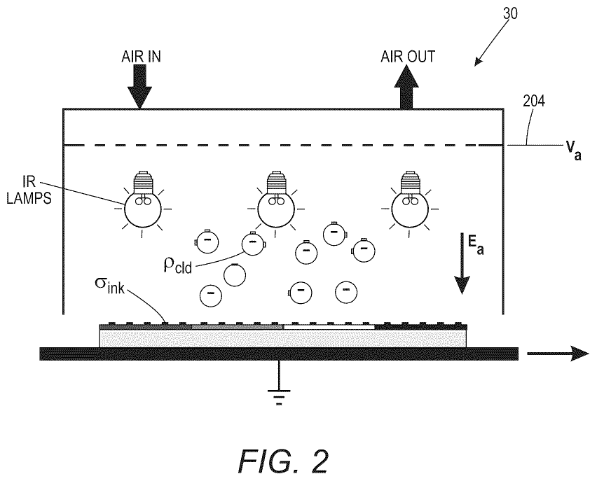

A schematic depicting the inside of the dryer 30 is shown in FIG. 2. The charged ink layer is heated in the dryer by IR lamps to increase the vapor pressure of the liquid ink. The evaporated ink components (water and co-solvents) form a charged vapor cloud (ρ_{cld}) above the media surface. Since σᵢₙₖ and ρ_{cld} are the same polarity, they repel each other. This repulsion causes the vapor cloud to move upward and away from the media. An electric field generator, such as perforated electrode 204 coupled to a DC voltage source Va, generates an electric field Eₐ that further drives the vapor cloud through the electrode so it can be exhausted from the dryer. As used in this document, the term “electric field generator” means a device configured to generate an electric field within a dryer to facilitate movement of a charge vapor cloud away from media within the dryer. The voltage of the electric field generator, which in this example is the perforated electrode 204, corresponds to the grid voltage of the electrostatic charge generator 32 with a small offset, i.e., Vₐ=V_{grid}+ΔVₐ, such that Eₐ is −ΔVₐ/g, where g is the gap between the electrode and paper surface. A typical value for Eₐ is within a range of 50-150 V/m. The electrostatic field generator is positioned above the lamps. This mechanism improves the diffusion of the vapor in the boundary layers and raises the evaporation rates. Assuming a diffusion constant of water vapor in air of 20×10⁻⁶ m²/s and a boundary layer thickness of 2 mm, the drift velocity of uncharged water vapor in the boundary is of the order of 0.01 m/s. Assuming a mobility of charged ions in air of 1×10⁻⁴ m²/V-s, the velocity of charged vapor in a field of 100 V/m is enhanced by an additional 0.01 m/s, i.e., which is a potential doubling of the evaporation rates. Another effect occurring in this embodiment is the polarization of the water dipoles in an electric field that weaken the intermolecular bonds at the ink surface and enhance phase change. The belt is made of a thermally conductive material and is electrically grounded when passing through the dryer 30. This configuration of the dryer 30 can be adapted to dry an ink image that has been formed on a heated drum in a known manner. Additionally, multiple dryers can be positioned about such a heated drum.

With continued reference to FIG. 1, a return path 72 is provided in printer 10 to receive a sheet from the media transport 42 after a substrate has passed through the dryer 30. The sheet is moved by the rotation of pulleys in a direction opposite to the direction of movement in the process direction past the printheads. An actuator 40 operatively connected to pivot 88 is operated by the controller 80 to either block entry to the return path 72 and direct the media to the receptacle 56 or direct the media to the return path 72. Pivoting member 82 is operated by the controller 80 to either direct the sheet along a curved portion of the return path 72 into inverter 76 so the sheet is turned over for duplex printing or along the straight portion of the return path 72. When the sheet follows the straight portion, the inverter 76 is bypassed and the side of the sheet previously printed can be printed again. The controller operates one of the actuators 40 to move the pivoting member 82 clockwise to direct a sheet into the inverter 76 and counterclockwise to bypass the inverter. Regardless of whether the substrate is inverted or not, it merges into the job stream being carried by the media transport 42 when controller 80 operates another actuator 40 to rotate pivoting member 86 to provide ingress of a sheet S from return path 72 to the job stream entering the print zone.

As further shown in FIG. 1, the printed media sheets S not diverted to the return path 72 are carried by the media transport to the sheet receptacle 56 in which they are be collected. Before the printed sheets reach the receptacle 56, they pass through a cooler 86 and then by an optical sensor 84B. The cooler 86 includes blowers, fans, or refrigerant coils to cool the printed media sheets that were heated by the dryer 30 to fix at least partially the ink to the media sheets. The cooled media sheets are safer to handle than sheets that have not been cooled. The optical sensor 84B generates image data of the printed sheets and this image data is analyzed by the controller 80 to determine whether the sheets are being sufficiently dried to prevent ink from being rubbed off the media and onto the baffles in the cooler. If ink is being removed from the sheets by the baffles, then controller 80 adjusts the operation of the electrostatic charge generator 32 and the components within the dryer 30 accordingly. Additionally, sheets that are printed with test pattern images are printed at intervals during the print job. Image data of these test pattern images generated by optical sensor 84B are analyzed by the controller 80 to determine which inkjets, if any, that were operated to eject ink into the test pattern did in fact do so, and if an inkjet did eject an ink drop whether the drop landed at its intended position with an appropriate mass. Any inkjet not ejecting an ink drop it was supposed to eject or ejecting a drop not having the correct mass or landing at an errant position is called an inoperative inkjet in this document. The controller can store data identifying the inoperative inkjets in database 92 operatively connected to the controller 80. These sheets printed with the test patterns are sometimes called run-time missing inkjet (RTMJ) sheets and these sheets are discarded from the output of the print job. A user can operate the user interface 50 to obtain reports displayed on the interface that identify the number of inoperative inkjets and the printheads in which the inoperative inkjets are located. For sheets that are not inverted and merged into the job stream by the operation of pivoting member 86, optical sensor 84A generates image data of the printed side and the controller 80 uses that image data to register the sheets and to operate the ejectors in the printhead to further print images on the previously printed sheet sides. The optical sensors 84A and 84B can be a digital camera, an array of LEDs and photodetectors, or other devices configured to generate image data of a passing surface. While FIG. 1 shows the printed sheets as being collected in the sheet receptacle 56, they can be directed to other processing stations (not shown) that perform tasks such as folding, collating, binding, and stapling of the media sheets.

Operation and control of the various subsystems, components and functions of the machine or printer 10 are performed with the aid of a controller or electronic subsystem (ESS) 80. The ESS or controller 80 is operatively connected to the components of the printhead modules 34A-34D (and thus the printheads), the actuators 40, the power supply 36 for the electrostatic charge generator 32, the components within the dryer 30, and the optical sensors 84A and 84B. The ESS or controller 80, for example, is a self-contained computer having a central processor unit (CPU) with electronic data storage, and a display or user interface (UI) 50. The ESS or controller 80, for example, includes a sensor input and control circuit as well as a pixel placement and control circuit. In addition, the CPU reads, captures, prepares, and manages the image content data flow between image input sources, such as a scanning system or an online or a work station connection (not shown), and the printhead modules 34A-34D. As such, the ESS or controller 80 is the main multi-tasking processor for operating and controlling all of the other machine subsystems and functions, including the printing process.

The controller 80 can be implemented with general or specialized programmable processors that execute programmed instructions. The instructions and data required to perform the programmed functions can be stored in non-transitory, computer-readable memory associated with the processors or controllers. The processors, their memories, the instructions and data stored in the memories, and the interface circuitry configure the controllers to perform the operations described below when the programmed instructions stored on the non-transitory, computer readable media are executed. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, ink image content data for an ink image to be produced is sent to the controller 80 from either a scanning system or an online or work station connection. The ink image content data is processed to generate the inkjet ejector firing signals delivered to the printheads in the modules 34A-34D. Along with the ink image content data, the controller receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer.

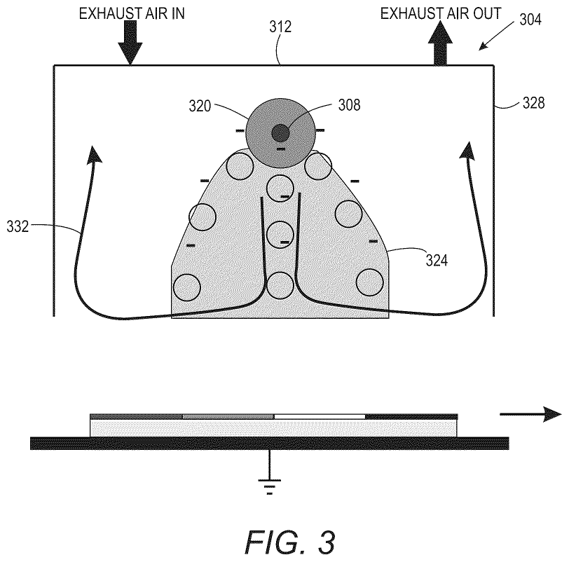

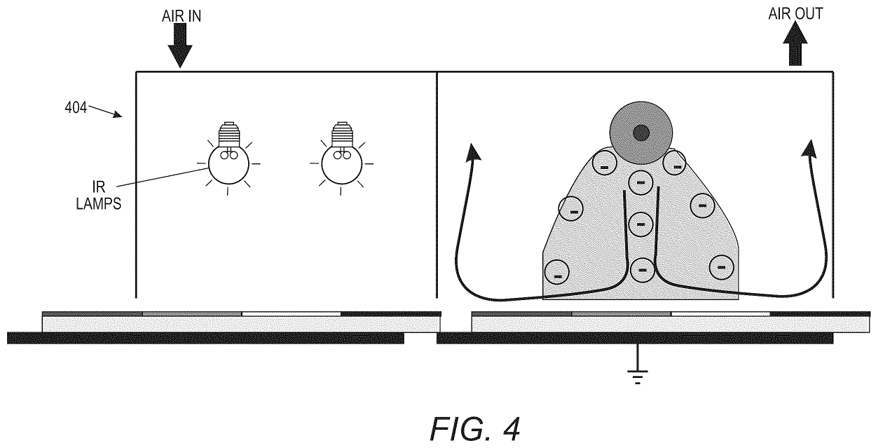

A drying device 304 that includes a corona generator to produce a corona wind to improve drying efficiency within a dryer is shown in FIG. 3. A corona generator can be implemented with a high voltage DC scorotron, a high voltage AC discorotron, or the like. As used in this document, the term “corona generator” means a device that generates electrostatic charge within a dryer to produce an air flow that facilitates movement of a charged or uncharged vapor cloud away from the media within the dryer. As shown in FIG. 3, the corona generator is implemented with a high voltage wire or pin electrode 308, referred to as a coronode, that is positioned within a housing 312 so the media passes beneath the coronode. Again, the belt 316 underneath the media or a portion of a heated drum opposite the coronode is coupled to electrical ground. The belt 316 or the drum is thermally conductive and is heated to apply heat to the media. Alternatively, a preheater 404 can be positioned to heat the media with IR lamps before entering the device 304 as shown in FIG. 4. In one embodiment, a high frequency AC current generator provides a high frequency AC current to the coronode 308 to generate an electrostatic field that forms a bipolar plasma or corona region 320 around the coronode and this region is followed by a unipolar drift region 324 in the electrostatic field between the coronode and the belt. The ionic drift induces an airflow due to the electro-hydrodynamic (EHD) effect, which is directed towards the media. This airflow, which is also referred to as the corona wind 332, disturbs the boundary layer slightly above the media surface and increases the diffusion of vapor in the boundary layer, thereby increasing evaporation rates. An exhaust fan 328 pulls the corona wind from the device 304. Additionally, the ionic drift directed toward the media can charge both the paper and ink, as well as the vapor cloud with the same polarity. This electrical repulsion also improves evaporation rates as noted above in the discussion of FIG. 2. The corona wind also aids in cooling the media before it exits the dryer 304. In one embodiment of the dryer 304 using an AC discorotron, the wire 308 has a diameter of 75 microns and the voltage on the wire is 5-10 kV at a frequency of 3-10 kHz. A DC corona generator may also be used in an alternative embodiment to implement the coronode. Carbon brushes can be positioned to contact the belt 316 after it exits the dryer 304 to discharge the belt before it returns to the print zone since electric fields in a printer print zone may induce satellites in the ink drops ejected toward the media and adversely affect image quality.

While the dryers described above use electrostatic charge and electric fields to improve evaporation rates for inks ejected onto media, they can also be used to improve evaporation rates for primers and other coatings applied to media to improve the properties of the media for printing. The media that is precoated before printing can pass through one of the dryer configurations described previously before being printed to facilitate drying of the primers or coatings before the media is printed. Also, to improve the electrical conductivity of transport belts currently being used in inkjet printers, the material from which the belt is made can be doped with electrical conductive materials before forming the belt.

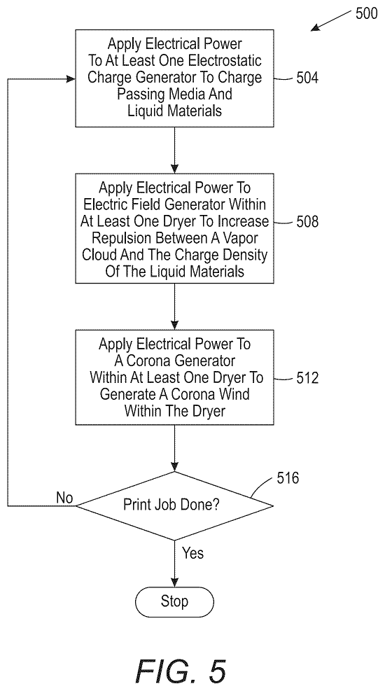

A process 500 for operating the inkjet printer of FIG. 1 to dry media onto which liquid materials have been ejected is shown in FIG. 5. In the description of the process, statements that the process is performing some task or function refers to a controller or general purpose processor executing programmed instructions stored in non-transitory computer readable medium operatively connected to the controller or processor to manipulate data or to operate one or more components in the printer to perform the task or function when the instructions are executed. The controller 80 noted above can be such a controller or processor. Alternatively, the controller can be implemented with more than one processor and associated circuitry and components, each of which is configured to perform one or more tasks or functions described herein. Additionally, the steps of the method may be performed in any feasible chronological order, regardless of the order shown in the figures or the order in which the processing is described.

The process 500 of FIG. 5 begins by applying electrical power to the electrostatic charge generator to direct electrostatic charge toward the media and liquid materials that have been ejected onto the media being moved by the media transport to charge the media and the ink image (block 504). Once the charged media and ink image enters a dryer an electric field generator can be coupled to electrical power to increase the repulsion between the vapor cloud in the dryer and the charge density of the liquid material on the media and increase the evaporation rate (block 508). Alternatively or additionally, this step can be implemented by coupling electrical power to a corona generator to generate a corona wind that stimulates movement within the vapor cloud to increase evaporation rates within the cloud (block 512). Thus, a single dryer having the configuration of FIG. 2 or FIG. 3 may be used in a printer or two dryers, one of each configuration, may be used in the printer. The operation of these components preceding or within a dryer continues until a print job is complete (block 516).

It will be appreciated that variants of the above-disclosed and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. An inkjet printer comprising:
a media transport configured to move media through the inkjet printer in a process direction; and
an electrostatic charge generator positioned to direct electrostatic charge toward the media being moved by the media transport to improve an evaporation rate in material applied to the media being moved by the media transport.

2. The inkjet printer of claim 1 further comprising:
an applicator configured to apply the material to the media being moved by the media transport before the media is printed; and
the electrostatic charge generator being positioned to direct the electrostatic charge toward the media being moved by the media transport after the applicator has applied the material to the media and before the material has dried.

3. The inkjet printer of claim 1 further comprising:
at least one printhead positioned opposite the media transport, the at least one printhead being configured to eject drops of ink onto the media being moved by the media transport; and
the electrostatic charge generator being positioned to direct the electrostatic charge toward the media being moved by the media transport after the at least one printhead has ejected drops of ink onto the media being moved by the media transport.

4. The inkjet printer of claim 3 wherein the electrostatic charge generator is one of a DC scorotron and an AC discorotron.

5. The inkjet printer of claim 3 further comprising:
a dryer configured to direct heat toward the media as the media transport moves the media through the dryer; and
an electric field generator positioned within the dryer to direct an electric field perpendicular to the media passing through the dryer.

6. The inkjet printer of claim 5, the electric field generator further comprising:
a perforated electrode that is coupled to a voltage supply to generate the electric field to move charged evaporated material away from the media within the dryer, through the perforated electrode, and out of the dryer.

7. The inkjet printer of claim 3, the dryer further comprising:
a dryer configured to direct heat toward the media as the media transport moves the media through the dryer; and
a corona generator positioned within the dryer to direct a corona wind toward media passing through the dryer.

8. The inkjet printer of claim 7 wherein the corona generator is a coronode.

9. The inkjet printer of claim 7 wherein the coronode is an electrically conductive wire.

10. The inkjet printer of claim 9 wherein the electrically conductive wire has a diameter of 75 microns.

11. A method for drying ink in an inkjet printer comprising:
operating a media transport to move media through the inkjet printer in a process direction; and
operating an electrostatic charge generator to direct electrostatic charge toward the media being moved by the media transport to improve an evaporation rate in material applied to the media being moved by the media transport.

12. The method of claim 11 further comprising:
applying the material to the media being moved by the media transport before the media is printed; and
operating the electrostatic charge generator to direct the electrostatic charge toward the media being moved by the media transport after the applicator has applied the material to the media and before the material has dried.

13. The method of claim 11 further comprising:
operating at least one printhead to eject drops of ink onto the media being moved by the media transport; and
operating the electrostatic charge generator to direct the electrostatic charge toward the media being moved by the media transport after the at least one printhead has ejected drops of ink onto the media being moved by the media transport.

14. The method of claim 13 wherein the operation of the electrostatic charge generator includes operating one of a DC scorotron and an AC scorotron.

15. The method of claim 13 further comprising:
operating a dryer to direct heat toward the media as the media transport moves the media through the dryer; and
operating an electric field generator within the dryer to direct an electric field perpendicular to the media within the dryer.

16. The method of claim 15, the operation of the electric field generator further comprising:
coupling a perforated electrode to a voltage supply to generate the electric field to move charged evaporated material away from the media within the dryer, through the perforated electrode, and out of the dryer.

17. The method of claim 13 further comprising:
operating a dryer to direct heat toward the media as the media transport moves the media through the dryer; and
operating a corona generator within the dryer to direct a corona wind toward media within the dryer.

18. The method of claim 17, the operation of the corona generator further comprising:
coupling a coronode to an electrical voltage.

19. The method of claim 18, the coupling of the coronode further comprising:
coupling an electrically conductive wire to the electrical voltage.

20. The method of claim 19 wherein the electrically conductive wire has a diameter of 75 microns.
